(19) United States
(12) Patent Application Publication
(10) Pub. No.: US 2008/0021661 A1
(43) Pub. Date: Jan. 24, 2008

(54) FIELD ADJUSTMENT FOR ENGINE MONITORING SYSTEM

(76) Inventors: Andrew Thompson, Longueuil (CA); Phuc Luong Nguyen, Brossard (CA)

Correspondence Address: OGILVY RENAULT LLP, 1981 MCGILL COLLEGE AVENUE, SUITE 1600, MONTREAL, QC, H3A2Y3, US

(21) Appl. No.: 11/459,463

(22) Filed: Jul. 24, 2006

(51) Int. Cl. G06F 19/00; G06F 17/40

(52) U.S. Cl. 702/34; 702/1; 702/127; 702/33; 702/182; 702/189; 702/187

(57) ABSTRACT

The present invention provides a performance mathematical representation for monitoring trend on engine condition from field engine data. Field engine performance data from multiple engine samples are provided and adjusted according to its associated average performance and an improved performance mathematical representation is constructed using the adjusted data.

### TECHNICAL FIELD

The invention relates generally to engine condition trend monitoring and, more particularly, to an improved engine condition trend monitoring system using field engine data to adjust its typical engine performance mathematical representation.

### BACKGROUND OF THE ART

Engine Condition Trend Monitoring (ETCM®) is an engine maintenance tool for engine diagnostic and health monitoring. It monitors trends in the engine condition and compares it to an engine performance mathematical representation for diagnostic. The ETCM® has the ability to alert in case of a deterioration condition or an abnormal condition of the engine and it optimizes maintenance planning. The engine performance mathematical representation is derived from the engine manufacturer performance model using limited test data from the Flying Test Bed (FTB) flight test or Altitude Test Facility (ATF). The ETCM® uses some predictions of the installation effects including intake loss, exhaust loss, bleed extraction and power extraction, applied to the performance mathematical representation. However, flight test does not accurately represent the installation and performance of the engine in the field and there is thus a misalignment between the performance mathematical representation and the field performance. Lack of data on the field installation causes additional inaccuracies.

Accordingly, there is a need to provide an improved ETCM® system.

### SUMMARY OF THE INVENTION

According to an embodiment, there is provided a method for providing a performance mathematical representation for engine condition trend monitoring from field engine data. The method comprises: providing field engine performance data sets from multiple engine samples, each one of the data sets corresponding to one of the engine samples, each one of the data sets being associated with an average performance deviation; adjusting the data sets according to its associated average performance deviation; and constructing the performance mathematical representation using the adjusted data sets.

According to another embodiment, there is provided an engine condition trend monitoring system comprising: an engine performance mathematical representation; an input for receiving a field engine performance data set from an engine sample; and a processing unit for improving the performance mathematical representation using the field engine performance data set.

According to yet another embodiment, there is provided a system for providing a performance mathematical representation for monitoring trend on engine condition from field engine data. The system comprises: means for providing field engine performance data sets from multiple engine samples, each one of the data set corresponding to one of the engine samples, each one of the data sets being associated with an average performance; means for adjusting the data sets according to its associated average performance; and means for constructing the performance mathematical representation using the adjusted data.

Further details of these and other aspects of the present invention will be apparent from the detailed description and figures included below.

### DESCRIPTION OF THE DRAWINGS

Reference is now made to the accompanying figures depicting aspects of the present invention, in which:

FIG. 1 is a flow chart illustrating a method used to provide an improved performance mathematical representation of an engine based on field engine performance data, according to one embodiment of the invention; and

FIG. 2 is block diagram showing an Engine Condition Trend Monitoring (ETCM ) system using field engine performance data to improve the performance mathematical representation of the engine.

### DETAILED DESCRIPTION

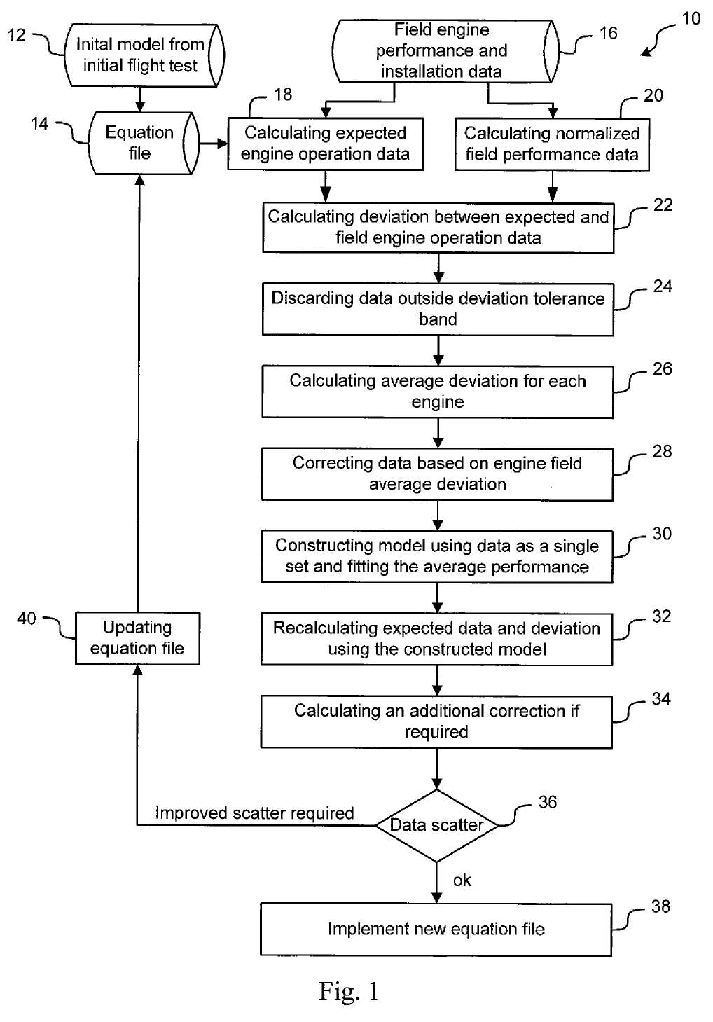

FIG. 1 illustrates a method 10 used to provide an improved mathematical representation of an engines performance based on a vast amount of real field engine performance data. An initial performance mathematical representation is provided using a flight test, a Flying Test Bed for instance, and the misalignment between the performance mathematical representation and the field performance is adjusted using field engine performance data. In addition to incorporating real field installation data, the improved performance mathematical representation allows for a much larger sample size (over hundred engines in some cases), when the engine manufacturer flight test provides only limited sample of about two or three engines. In order to construct the performance mathematical representation, a data set associated to each engine sample is corrected according to the engine average performance such that the adjusted average performance of each engine sample is the same. The resultant data sets are combined in a single set of data used to fit the performance mathematical representation. For each of the engine samples, correction factors are derived for each of the engine values to be monitored (typically spool speeds, gas path temperatures and fuel flow) based on the average deviation of the sample from the baseline performance mathematical representation. These correction factors remove the effects of engine-to-engine variation and any variation in installation effects.

According to one embodiment, the performance mathematical representation is provided as equations for each of the measured engine parameters. These equations are adjusted using field engine performance data. The initial performance mathematical representation 12 is provided using a flight test and is registered in an equation file 14. In step 16, real field engine performance data is acquired on multiple engine samples. Based on the equation file 14 and on the field engine performance data, the expected engine performance is calculated in step 18 and provides a baseline to which the field data is to be compared. The field engine performance data 16 is normalized in step 20 using standard methods to remove the effect of ambient temperature and pressure variation and reduce the data to a single standard operating condition. The deviation between the expected and the field engine performance data is calculated in step 22 and field performance data is cleaned from diverging data by discarding data outside a deviation tolerance band is discarded in step 24. In step 26, the average deviation between the expected engine performance data and the cleaned field performance data is calculated for each engine sample and, in step 28, the data is corrected for each engine sample according to the calculated average deviation such that the adjusted average performance of each engine sample is the same. The average deviation of each field engine parameter from the expected performance parameter is added to the corresponding measured field engine parameter to align all the data to the same reference. In step 30, the sets of field performance data from all the engine samples are combined into a single data set and a performance mathematical representation is constructed by fitting the equations on the single data set such that the performance mathematical representation represents the average performance of all the engine samples.

Using the newly constructed performance mathematical representation, the expected engine performance and the deviation between the expected and the field performance data are recalculated in step 32. If there remain trends in the data that cannot be well represented by the mathematical representation, an additional correction factor is calculated in step 34 to remove the trend. Typically this will be a correction factor to remove trends with altitude that cannot be captured by a simple mathematical representation of the engine performance. It may also include the impact of changes in customer installation effects like the level of bleed extraction if it is measured. Then, in step 36, the data scatter over the constructed performance mathematical representation is calculated and if an improved scatter is required, the process is carried out again using the equation file updated in step 40 using the constructed performance mathematical representation. When the data scatter is appropriate in step 36, the new improved equation file is implemented in step 38.

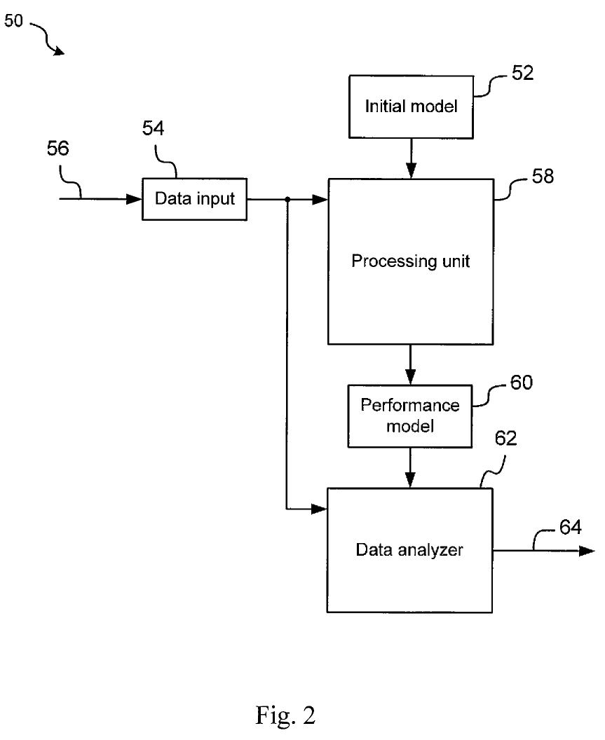

FIG. 2 shows an ETCM® system 50 using field engine performance data sets 56 from multiple engine samples to improve the performance mathematical representation 60 of the engine. An initial mathematical representation 52 is provided using a flight test of the engine, such as the manufacturer flight test. The system includes a data input 54 for receiving field engine performance data set 56 from the multiple engine samples and a processing unit 58 for improving the performance mathematical representation 1 60 using the received field engine performance data sets 56. The ETCM® system 50 also includes a data analyzer 62 for analyzing a field engine performance data set 56 using the performance mathematical representation 60 and providing engine condition trend monitoring information 64.

Calculation of the improved performance mathematical representation can be done at one single time, when sufficient data is available to provide a sufficient statistical sample or alternatively, the performance mathematical representation can be constantly updated using new available field engine performance data.

It should be appreciated that the process can be carried out based on a small sample of data, but the statistical significance of the result is then decreased.

In one embodiment, the improved ETCM® only consider field performance data acquired during the early life of an engine in order to eliminate the impact of the engine performance deterioration on the improved performance mathematical representation. A drawback of this procedure is the reduction of the data sample available for improving the performance mathematical representation.

The above description is meant to be exemplary only, and one skilled in the art will recognize that changes may be made to the embodiments described without department from the scope of the invention disclosed. Modifications which fall within the scope of the present invention will be apparent to those skilled in the art, in light of a review of this disclosure, and such modifications are intended to fall within the appended claims.

What is claimed is:

1. A method for providing a performance mathematical representation for engine condition trend monitoring from field engine data, said method comprising:
providing field engine performance data sets from multiple engine samples, each one of said data sets corresponding to one of said engine samples, each one of said data sets being associated with an average performance deviation;
adjusting said data sets according to its associated average performance deviation; and constructing said performance mathematical representation using the adjusted data sets.

2. The method as defined in claim 1, wherein said adjusting comprises correcting said data sets such that a corrected average performance of each one of said engine samples is the same.

3. The method as defined in claim 2, wherein said performance mathematical representation fits the average performance of said multiple engine samples.

4. The method as defined in claim 1, wherein said constructing comprises fitting said performance mathematical representation on said adjusted data sets.

5. The method as defined in claim 1, wherein said constructing comprises combining said data sets into a single set of data and fitting said performance mathematical representation on said single set.

6. The method as defined in claim 1, further comprising providing an initial performance mathematical representation.

7. The method as defined in claim 6, further comprising calculating expected engine performance data sets for each of said engine samples using said initial performance mathematical representation.

8. The method as defined in claim 7, wherein said calculating is made using said field engine performance data sets.

9. The method as defined in claim 6, further comprising calculating deviations between said expected engine performance data sets and said field engine performance data sets.

10. The method as defined in claim 9, further comprising discarding data associated with a value of said deviations greater than a tolerance value to provide a cleaned field engine performance data sets.

11. The method as defined in claim 9, further comprising calculating said average deviation by averaging the calculated deviations over each one of said engine samples.

12. The method as defined in claim 1, further comprising calculating an additional adjustment if required.

13. The method as defined in claim 1, further comprising updating said performance mathematical representation.

14. The method as defined in claim 13, further comprising performing again said adjusting and said constructing using the updated performance mathematical representation if improvement is required.

15. An engine condition trend monitoring system comprising:
an engine performance mathematical representation;
an input for receiving a field engine performance data set from an engine sample; and
a processing unit for improving said performance mathematical representation using said field engine performance data set.

16. The engine condition trend monitoring system as defined in claim 15, further comprising a data analyzer for analyzing field engine performance data using said performance mathematical representation and providing engine condition trend monitoring information.

17. The engine condition trend monitoring system as defined in claim 15, wherein said processing unit is further for adjusting said data according to its associated average performance.

18. The engine condition trend monitoring system as defined in claim 17, wherein said input is for receiving field engine performance data sets from a plurality of engine samples.

19. The engine condition trend monitoring system as defined in claim 18, wherein said adjusting is done such that an adjusted average performance of each one of said engine samples is the same.

20. The engine condition trend monitoring system as defined in claim 17, wherein said constructing comprises fitting said performance mathematical representation on said adjusted data.

21. The engine condition trend monitoring system as defined in claim 18, wherein said performance mathematical representation fits an average performance of said plurality of engine samples.

22. The engine condition trend monitoring system as defined in claim 21, wherein said average performance is calculated over one of said engine samples.

23. The engine condition trend monitoring system as defined in claim 15, further comprising an initial performance mathematical representation.

24. A system for providing a performance mathematical representation for monitoring trend on engine condition from field engine data, said system comprising:
means for providing field engine performance data sets from multiple engine samples, each one of said data set corresponding to one of said engine samples, each one of said data sets being associated with an average performance;
means for adjusting said data sets according to its associated average performance; and
means for constructing said performance mathematical representation using the adjusted data.
